(19) United States
(12) Patent Application Publication
(10) Pub. No.: US 2005/0175012 A1
(43) Pub. Date: Aug. 11, 2005

(54) System and method for transmitting and receiving data frames in a NAK-based window protocol

(75) Inventors: Praveen Gupta, San Diego, CA (US); Srinivasan Balasubramanian, San Diego, CA (US); Radhachandran Padmanaban, San Diego, CA (US)

Correspondence Address: COATS & BENNETT, PLLC, P O BOX 5, RALEIGH, NC, 27602, US

(73) Assignee: Telefonaktiebolaget L.M. Ericsson (publ)

(21) Appl. No.: 11/026,000

(22) Filed: Dec. 31, 2004

Related U.S. Application Data
(60) Provisional application No. 60/542,731, filed on Feb. 6, 2004.

(51) Int. Cl. H04L 12/28

(52) U.S. Cl. 370/394

(57) ABSTRACT

In a NAK-based window transmission protocol where the transmitter retains transmitted data frames in a retransmission queue, one or more transmitted data frames are discarded as the number of data frames approaches the available queue capacity. A message, such as a control frame, is transmitted to the receiver indicating which of the retained data frame copies were discarded. The queue stall avoidance mechanism operates at the transmitter, which has direct knowledge of its queue utilization. By avoiding a queue stall, the transmitter may continue to receive incoming data packets for transmission to a receiver. That is, the transmitter can be configured to prioritize sending new data over retaining previously transmitted data for support of data retransmissions.

### RELATED APPLICATIONS

This application claims priority to Provisional U.S. Patent Application 60/542,731 filed Feb. 6, 2004, which is incorporated herein by reference.

### BACKGROUND

The present invention relates generally to the field of wireless communication systems and in particular to a system and method for transmitting and receiving data frames in a NAK-based window protocol.

Modern communications systems, including wireless systems, use a layered architecture, with separate protocols for performing defined functions at each layer. The layered protocol approach allows upper level logical operations to be implemented without regard to the lower level physical operations of transmission and reception, error correction and the like.

The IS-2000 CDMA wireless communications standard defines a protocol known as the Radio Link Protocol (RLP) for implementing physical layer communications between a Radio Access Network and a Mobile Station. RLP is unaware of higher layer framing; it operates on a featureless octet stream, delivering the octets in the order received. RLP has procedures to substantially reduce the error rate exhibited by CDMA traffic channels. There is no direct relationship between higher layer packets and the RLP data frames; a large packet may span multiple data frames, or a single RLP data frame may contain all or part of several small higher layer packets.

RLP is a NAK-based window protocol. That is, the receiver does not acknowledge each received data frame. Rather, the receiver receives and processes data frame in order (according to sequence numbers associated with each data frame), sending a Negative AcKnowledgement (NAK) when a data frame is “missed”—either not received or received with unrecoverable errors. The receiver may send a NAK with the sequence number of the missed data frame when one or more data frames are received that are not in contiguous sequential order to previously received data frames. The NAK is a request to re-transmit the missing data frame. However, the NAK need not be sent immediately; the receiver may continue to receive data frames ahead of the missed frame, hoping to receive the missed frame in an un-requested retransmission. The receiver may also optionally occasionally transmit a “fill” frame, indicating all data frames up to a particular sequence number have been correctly received.

To comply with the NAK protocol, the transmitter must retain a copy of each transmitted data frame in a retransmission queue, against the possibility of receiving a NAK request. Once a NAK is received, the transmitter knows that the receiver has correctly received all data frames previous to the data frame identified in the NAK request. Thus, only upon receiving a NAK or fill frame can the transmitter discard copies of previously transmitted data frames, freeing space in its retransmission queue. For any fixed size retransmission queue—and in particular for the fixed queue size imposed by the RLP protocol, as discussed herein—if the receiver properly receives all transmitted data frames, or does not promptly NAK a missing frame, and does not transmit a fill frame, the transmitter may completely fill the retransmission queue with copies of transmitted data frames. Once this occurs the transmitter must stall, and cannot accept new data frames for transmission to the receiver.

### SUMMARY

In one aspect, the present invention relates to a method of preventing transmitter queue stalls in a transmitter. Data frames are successively transmitted to a receiver, each data frame identified by a sequence number. A copy of each transmitted data frame is retained in a queue for possible retransmission, until receiving a message, such as a control frame, from the receiver indicating the data frame was correctly received, or until a maximum time for retransmission is exceeded. One or more the retained data frame copies are discarded responsive to the number of retained data frame copies approaching the available queue capacity, and a message, such as a control frame, is transmitted to the receiver indicating which of the retained data frame copies were discarded.

In another aspect, the present invention relates to a transmitter. The transmitter includes an input queue for receiving new data to be transmitted to a receiver and circuitry for transmitting data frames to the receiver. The transmitter also includes memory, such as a re-transmit queue, for storing copies of transmitted data frames not acknowledged as received by the receiver, and a controller operative to discard one or more the copies of transmitted data frames when the copies approach an available capacity of the memory. This method of operation permits the transmitter to send new data instead of waiting for re-transmit queue availability.

In yet another aspect, the present invention relates to a method of receiving frames transmitted by a transmitter and delivering the frames to a higher protocol layer. Data frames are received from a transmitter, each frame identified by a sequence number. Received, sequential data frames are delivered to the higher protocol layer. Received, non-sequential data frames are stored in an out-of-order queue. Upon receiving a message from the transmitter, such as a control frame, including a flush sequence number and indicating that one or more transmitted frame copies retained by the transmitter for possible retransmission were discarded, all received data frames up to the flush sequence number are delivered to the higher protocol layer and the beginning of the out-of-order queue is reset to the flush sequence number.

In still another aspect, the present invention relates to a receiver. The receiver includes a receiver for receiving data frames from a transmitter, each the data frame having a sequence number. The receiver also includes an output for delivering received data frames to a higher protocol layer, and memory for storing received, non-sequential data frames prior to delivery to the higher protocol layer, pending the receipt of intervening sequential data frames. In addition, the receiver includes a controller operative to deliver the non-sequential data frames to the higher protocol layer responsive to detecting that memory used for storing non-sequential data frames is at or near a capacity limit. The controller is further operative to deliver non-sequential data frames to higher protocol layers upon receipt of a message from the transmitter that copies of the intervening sequential data frames retained by the transmitter for possible retransmission have been discarded.

### BRIEF DESCRIPTION OF DRAWINGS

FIG. 1 is a functional block diagram of a wireless communication system.

FIG. 2 is protocol layer diagram for the Uₘ reference point.

FIG. 3 is a functional diagram of the RLP transmitter and receiver buffers.

### DETAILED DESCRIPTION

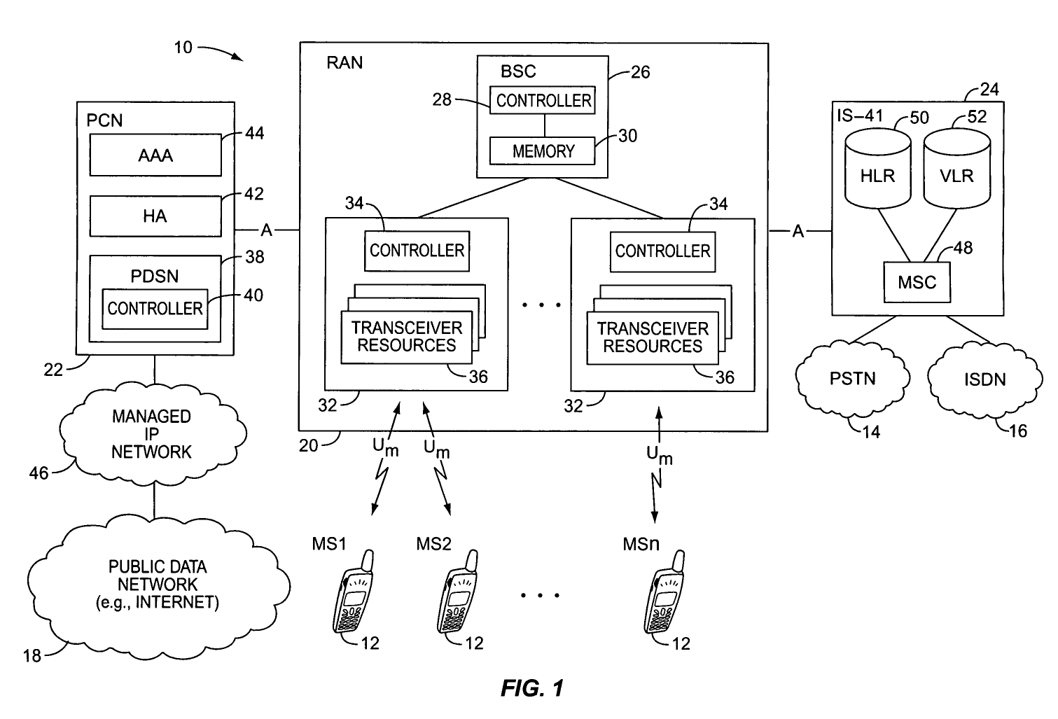

FIG. 1 illustrates an exemplary wireless communication network generally referred to by the numeral 10. In an exemplary embodiment, network 10 is based on cdma2000, 1xEV-DO/DV standards as promulgated by the Telecommunications Industry Association (TIA), although the present invention is not limited to such implementations. Here, network 10 communicatively couples one or more mobile stations (MSs) 12 to the Public Switched Telephone Network (PSTN) 14, the Integrated Data Services Network (ISDN) 16, and/or a Public Data Network (PDN) 18, such as the Internet. In support of this functionality, the network 10 comprises a Radio Access Network (RAN) 20 connected to a Packet Core Network (PCN) 22 and an IS-41 network 24 across an A interface.

The RAN 20 typically comprises one or more Base Station Controllers (BSCs) 26, each including one or more controllers 28 or other processing systems, with associated memory 30 for storing necessary data and parameters relating to ongoing communications activity. Generally, each BSC 26 is associated with one or more Base Stations (BSs) 32. Each BS 32 comprises one or more controllers 34, or other processing systems, and assorted transceiver resources 36 supporting radio communication with MSs 12, such as modulators/demodulators, baseband processors, radio frequency (RF) power amplifiers, antennas, etc.

BSs 32 may be referred to as Base Transceiver Systems (BTSs) or Radio Base Stations (RBSs). In operation, BSs 32 transmit control and traffic data to MSs 12, and receive control and traffic data from them over the Uₘ interface. BSC 26 provides coordinated control of the various BSs 32. The BSC 26 also communicatively couples the RAN 20 to the PCN 22.

The PCN 22 comprises a Packet Data Serving Node (PDSN) 38 that includes one or more controllers 40, or other processing systems, a Home Agent (HA) 42, and an Authentication, Authorization, and Accounting (AAA) server 44. Typically, the PCN 22 couples to the PDN 18 through a managed IP network 46, which operates under the control of the network 10. The PDSN 38 operates as a connection point between the RAN 16 and the PDN 18 by establishing, maintaining and terminating Point-to-Point Protocol (PPP) links, and further provides Foreign Agent (FA) functionality for registration and service of network visitors. HA 42 operates in conjunction with PDSN 38 to authenticate Mobile IP registrations and to maintain current location information in support of packet tunneling and other traffic redirection activities. Finally, AAA server 44 provides support for user authentication and authorization, as well as accounting services.

The BSC 26 also communicatively couples the RAN 20 to the IS-41 network 24. The IS-41 network 24 includes a Mobile Switching Center (MSC) 48 accessing a Home Location Register (HLR) 50 and Visitor Location Register (VLR) 52 for subscriber location and profile information. The MSC 48 establishes circuit-switched and packet-switched communications between the RAN 20 and the PSTN 16 and ISDN 16.

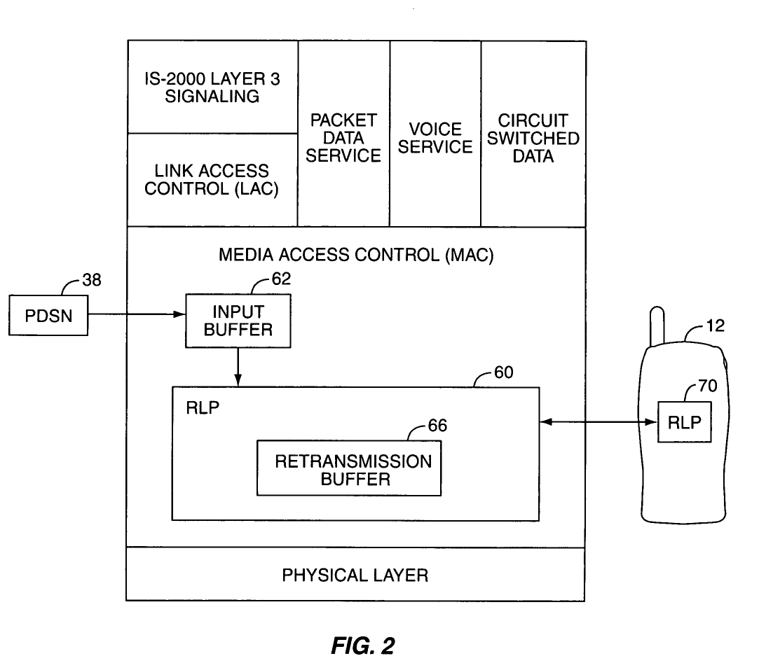

The protocol layer structure of the Uₘ interface—defining communications between the RAN 20 and the MSs 12—is depicted in FIG. 2. At the upper layers, the PCN 22 provides Packet Data Service, and the IS-41 network 24 provides Voice Service and Circuit Switched Data, as described above. The IS-2000 Layer 3, also called the Signaling Layer, comprises base station and mobile station interoperability procedures and associated signaling that allow the end user to receive service.

The Link Access Control (LAC) layer provides transport services over logical channels for Layer 3 signaling. The logical channels may be dedicated or common. Dedicated channels are mapped to physical channels assigned to a single user, such as for transmitting voice communications. Common channels are mapped to physical channels shared by multiple users, and may carry system overhead traffic, paging messages, and the like. The LAC encapsulates Layer 3 messages into LAC Protocol Data Units (PDU) that are subject to fragmentation and reassembly to make them suitable for transport by the lower layers.

The Media Access Control (MAC) layer maps the logical channels to physical channels and coordinates the use of physical resources. The MAC also enforces the negotiated Quality of Service (QoS) level. The MAC implements a multiplexing and demultiplexing function to allow access to the medium to both PDUs received from the LAC and data units received from user applications. The MAC ensures reliable transmission of data—nearly error-free and in order—through the Radio Link Protocol (RLP) and other protocols. The RLP is a specialized form of selective-repeat Automatic Repeat Request (ARQ) protocol, defined in the IS-707 standard, which is incorporated by reference herein in its entirety. While not explicitly handled by the MAC layer, the RLP is functionally and conceptually part of the MAC layer. As depicted in FIG. 2, the RLP 60 receives data from the PDSN 38, storing the data in a buffer or queue 66. The RLP communicates by data and control frames to a peer RLP 70 in a mobile station 12.

The RLP is a negative acknowledgement (NAK)-based ARQ protocol, described above. RLP operation—data transmission and retransmission—proceeds according to parameters that are negotiated when the service is connected (e.g., at call establishment). RLP parameters are contained in a data structure known as the RLP Block of Bits (RLP-BLOB). These parameters include the number of NAKs per round, the number of rounds, and optionally an estimated Round Trip Time (RTT), or the round-trip delay between the Base Station 32 and the Mobile Station 12. For Forward Packet Data Channel (F-PDCH) operation, the RLP-BLOB may additionally include a DELAY_DETECTION_WINDOW (DDW) parameter. The RTT is determined by a SYNC procedure between the BS 32 and the MS 12 at the outset of the service connection.

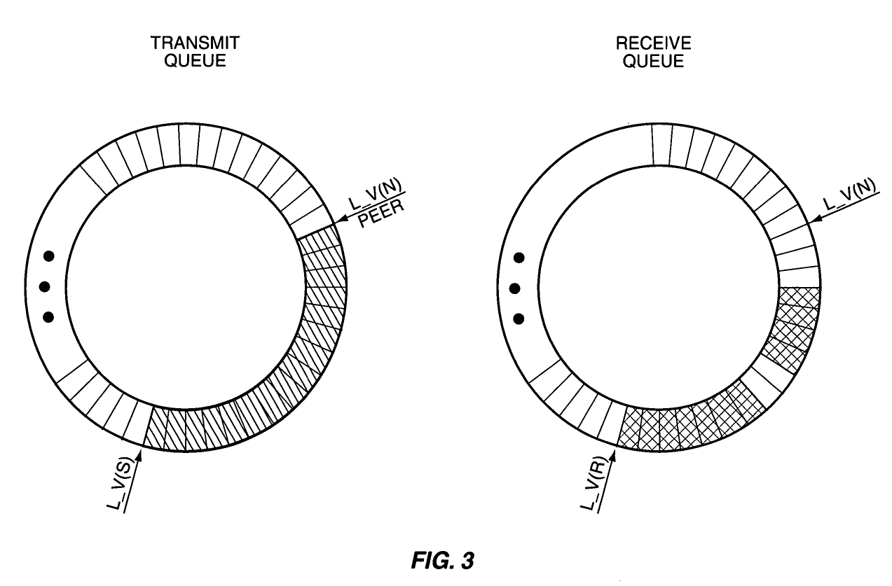

Once the RLP parameters are initialized, data transfer may proceed. The RLP data frame sequence space comprises a 12-bit value, for 4096 sequence numbers. Each data frame is identified by a sequence number, and transmission and reception of data frames is tracked by pointers to queues maintained in the RLP transmitter and receiver. The queues are conceptually configured as circular buffers, as depicted in FIG. 3. The four pointers have the following meanings:

L_V(S): 12-bit sequence number of the next data frame to be transmitted.

L_V(R): 12-bit sequence number of the next expected new data frame.

L_V(N): 12-bit sequence number of the next data frame needed for sequential delivery.

L_V(N)_{PEER}: An estimate of the peer RLP's L_V(N).

The transmitter advances L_V(S) as it transmits data frames to the receiver. Upon receipt of a new data frame, if the received data frame is the next sequential data frame (by sequence number) to those previously received in sequential order, the receiver advances L_V(N). If the new data frame falls between L_V(N) and L_V(R), the data frame is stored in the receiver queue and no pointer is updated. If the new data frame is beyond the most advanced data frame received (by sequence number), the receiver advances L_V(R) to the sequence number of the received data frame. If a received data frame has a sequence number less than L_V(N) (as defined below), the receiver interprets it as a retransmission of an already properly received, sequential data frame, and discards it.

The receiver maintains a pointer L_V(N)_{PEER}, which is the transmitter's best estimate of the value of the pointer L_V(N) at the receiver. The data frames between L_V(N)_{PEER} and L_V(S) comprise the retransmission queue. This queue stores copies of previously transmitted data frames, against the possibility of receiving a NAK request to retransmit one or more of the data frames.

Mathematical and logical operations on the sequence numbers are conducted modulo-4096 (i.e., 2¹²). In particular, greater-than and less-than operators are defined. The following ranges of sequence numbers are considered to be greater than or less than a data frame sequence number N:

N is greater than the sequence numbers (N-2048)%4096 to (N-1)%4096

N is less than the sequence numbers (N+1)%4096 to (N+2047)%4096

That is, the preceding half of the circular buffer is defined as less than N; the following half of the circular buffer is defined as greater than N. Because the receiver will discard any received data frame with a sequence number less than L_V(N), and because the definition of “less than” comprises the preceding half of the buffer, the transmitter can never advance L_V(S) more than 2048 sequence numbers ahead of L_V(N)_{PEER}. Assuming L_V(N)_{PEER} accurately mirrors the receiver's L_V(N), to do so would mean the transmitter would be transmitting data frames that the receiver would consider less than L_V(N) and discard. As the data frames stored by the transmitter between L_V(N)_{PEER} and L_V(S) comprise the retransmission queue, the retransmission queue is effectively limited to half of the potential buffer size, or 2048 data frames. In practice, actual memory limitations at the transmitter may restrict the retransmit queue size to some value less than 2048 data frames.

Under poor channel conditions that generate a significant number of NAKs, or under fairly low data rates that allow for the relatively frequent sending of fill frames, a 2048-element retransmission queue may be sufficient. However, under the high data rates possible on the Packet Data Channels (PDCH), particularly under good channel conditions, the transmitter may experience a queue stall condition, wherein 2048 data frames are transmitted without receiving a NAK or fill frame. For example, assuming an average data throughput of 1 Mbps, the 2048-element retransmission queue will fill in:
≈2048*46*8/1 Mbps=754 msecs.

This number will be even smaller under peak operating conditions of 3 Mbps over F-PDCH. In a queue stall, the transmitter is unable to transmit new data frames to the receiver until the receiver NAKs, allowing the transmitter to advance L_V(N)_{PEER} and discard some of the copies of previously transmitted data frames. The queue stall may force the transmitter to discard incoming data frames and allow higher layer protocols to deal with the error. This queue stalling and discarding of new data may not be the best option for applications desiring certain QoS behaviors.

There are several ways to address the queue stall problem. For example, a queue stall will not occur when the number of NAKs per round parameter is set to 1 and if the Round Trip Time (RTT)+Delay Detection Window (DDW)+REXMIT_TIMER is less then 754 ms for the 1 Mbps data rate. Even lower DDW & REXMIT_TIMER values will be required to support higher data rates. However, lower values of DDW have the negative effect of inducing unnecessary NAKs under regular operating scenarios, and hence this is not a desirable option. As another alternative, the receiver could use implementation based schemes to prevent queue stalls by not waiting for the full NAK rounds, based on implementation-specific criteria. This solution places the decision at the receiver, which does not have any knowledge of the buffering at the transmitter, and hence may lead to incorrect decisions in many scenarios.

According to the present invention, the transmitter may prevent queue stalls by advancing the L_V(N)_{PEER} pointer when the retransmission queue approaches the available capacity. This effectively discards the earliest (by sequence number) retransmission data frame copies stored in the retransmission queue. If the protocol allows, the transmitter then supplies the new value of the L_V(N)_{PEER} pointer to the receiver, so the receiver may update the value of its corresponding L_V(N) pointer.

In one embodiment, the transmitter supplies the updated L_V(N)_{PEER} value (referred to herein as L_V(N)_{NEW}) to the receiver in a Skip Frame. As defined herein, a Skip Frame has the format of a fill frame, with the seq-number field containing the sequence number for the new proposed L_V(N) pointer. The fields of a Skip Frame are defined as follows:

| Field | Length (bits) |
|---|---|
| SEQ | 8 |
| CTL | 4 |
| SEQ_HI | 4 |
| Padding | Variable |

SEQ—This field contains the least signification 8 bits of the new proposed L_V(N).

CTL—This field shall be set to ‘1111’. This identifies that the frame as a fill frame type.

SEQ_HI—This field shall contain the most significant 4 bits of the new proposed L_V(N).

Padding—Padding bits. As required to fill the remainder of the frame. These bits shall be set to ‘0’.

The transmitter-controlled queue stall avoidance solution of the present invention requires cooperative processing by the receiver upon receipt of a Skip Frame. In particular, the receiver should take the following actions, depending on the value of the new proposed L_V(N) in the Skip Frame. First, the receiver extracts the value L_V(N)_{NEW} from the Skip Frame according to the following equation:
L_{—}V(N)_{NEW}={SEQ+[SEQ_HI*256]}

The receiver then processes data frames as follows (wherein the operators <=, > and >= are modulo-4096 as described above):

If L_V(N)_{NEW}<=L_V(N), the Skip Frame is discarded. In this case, the transmitter has discarded only retransmission data frames that were already received in sequential order by the receiver, and delivered to a higher protocol layer.

If L_V(N)_{NEW}>L_V(N), the receiver delivers all received data frames whose sequence number is less than L_V(N)_{NEW} to the higher protocol layer. The receiver also removes all sequence numbers less than L_V(N)_{NEW} from the NAK-list. Any missing data frames will be addressed by error handling routines in the higher protocol layer(s) (e.g., TCP). Finally, the receiver sets L_V(N) to the value of L_V(N)_{NEW}.

If L_V(N)_{NEW}>=L_V(R), the receiver sets L_V(R) to the value of L_V(N)_{NEW}.

In this manner, the transmitter may place a greater priority on the delivery of new data frames than on the retention of copies of previously transmitted data frames retained against the possibility of a required retransmission. This capability may be desired or required in many high-data rate applications such as audio or video streaming that can tolerate some data loss but have low latency requirements for the delivery of new data frames. The present invention places control of the queue stall avoidance at the transmitter, where the queue resource allocation is known, and can be best optimized.

Although the present invention is explicated herein with reference to an RLP transmitter and RLP receiver, the present invention is not so limited, and may be advantageously applied in any NAK-based communication system with fixed size buffers. More generally, although the present invention has been described herein with respect to particular features, aspects and embodiments thereof, it will be apparent that numerous variations, modifications, and other embodiments are possible within the broad scope of the present invention. Accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of preventing transmitter queue stalls in a transmitter, comprising:
successively transmitting data frames to a receiver, each said frame identified by a sequence number;
retaining a copy of each transmitted data frame in a queue for possible retransmission, until receiving a message from the receiver indicating said data frame was correctly received; and
discarding one or more said retained data frame copies responsive to the number of retained data frame copies approaching an available queue capacity.

2. The method of claim 1, further comprising transmitting a message to the receiver indicating which said retained data frame copies were discarded.

3. The method of claim 1 further comprising, upon receiving a retransmission request from said receiver for a data frame copy that was discarded from said queue, transmitting to said receiver a message including the sequence number of the earliest retained data frame copy not discarded.

4. The method of claim 1 further comprising maintaining a pointer comprising the sequence number of the first retained data frame copy in said queue.

5. The method of claim 4 further comprising, when said one or more retained frame copies are discarded, advancing said pointer one sequence number for each said discarded frame, and transmitting the new value of said pointer to said receiver.

6. The method of claim 1 wherein said queue is organized as a circular buffer of a total sequence number N frames, and wherein said pointer is advanced modulo-N.

7. The method of claim 5 wherein said available queue capacity is at most N/2.

8. A transmitter, comprising:
an input for receiving data frames to be transmitted to a receiver;
a transmitter for transmitting said data frames to said receiver;
memory for storing copies of transmitted data frames not acknowledged as received by said receiver; and
a controller operative to discard one or more said copies of transmitted data frames when said copies approach an available capacity of said memory.

9. The transmitter of claim 8 wherein said controller is further operative to transmit to said receiver an indication of which said copes were discarded.

10. The transmitter of claim 9 wherein said controller complies with the Radio Link Protocol (RLP).

11. The transmitter of claim 10 wherein said memory is organized as a circular buffer of N elements, and wherein said controller maintains a pointer marking the beginning of a retransmit window holding said copies of transmitted data frames, and advances said pointer modulo-N for each said copy discarded.

12. The transmitter of claim 11 wherein upon discarding said copies and advancing said pointer, said controller transmits the new value of said pointer to said receiver.

13. A method of receiving frames transmitted by a transmitter and delivering said frames to a higher protocol layer, comprising:
receiving data frames from a transmitter, each said frame identified by a sequence number;
delivering received, sequential data frames to said higher protocol layer;
storing received, non-sequential data frames in an out-of-order queue; and
upon receiving a message from said transmitter including a flush sequence number and indicating that one or more transmitted frame copies retained by said transmitter for possible retransmission were discarded, delivering all received data frames up to said flush sequence number to said higher protocol layer and resetting the beginning of said out-of-order queue to said flush sequence number.

14. The method of claim 13 further comprising incrementing a last expected sequence number if a receiver memory buffer is full to create room for receiving new data frames from the transmitter.

15. The method of claim 14 wherein, upon receiving a message from said transmitter including a flush sequence number and indicating that one or more transmitted frame copies retained by said transmitter for possible retransmission were discarded, delivering all received data frames up to said flush sequence number to said higher protocol layer and resetting the beginning of said out-of-order queue to said flush sequence number

16. The method of claim 13 further comprising:
maintaining a pointer marking the beginning of said out-of-order queue; and
upon receiving said message from said transmitter, replacing said pointer value with said flush sequence number, and delivering all data frames in said out-of-order queue up to said flush sequence number to said higher protocol layer.

17. The method of claim 16 further comprising:
upon receiving a non-sequential data frame, adding the sequence number of at least the next sequential frame to a NAK-list.

18. The method of claim 17 wherein said transmitter and receiver comply with the Radio Link Protocol (RLP), said pointer marking the beginning of said out-of-order queue is L_V(N), said flush sequence number is L_V(N)_{NEW}, and further comprising:
maintaining a pointer L_V(R) marking the end of said out-of-order queue; and
upon receiving said message including L_V(N)_{NEW} from said transmitter,
if L_V(N)_{NEW}<=L_V(N), discarding said message,
if L_V(N)_{NEW}>L_V(N), delivering all data frames whose sequence number is less than L_V(N)_{NEW} to said higher protocol layer, removing all sequence numbers less than L_V(N)_{NEW} from said NAK-list, and setting L_V(N) to the value of L_V(N)_{NEW}; and
if L_V(N)_{NEW}>=L_V(R), setting L_V(R) to the value of L_V(N)_{NEW}.

19. A receiver, comprising:
a receiver for receiving data frames from a transmitter, each said data frame having a sequence number;
an output for delivering received data frames to a higher protocol layer;
memory for storing received, non-sequential data frames prior to delivery to said higher protocol layer, pending the receipt of intervening sequential data frames; and
a controller operative to deliver said non-sequential data frames to said higher protocol layer upon receipt of a message from said transmitter that copies of said intervening sequential data frames retained by said transmitter for possible retransmission have been discarded.

20. The receiver of claim 19 wherein said message from said transmitter includes the sequence number of the last said intervening sequential data frame discarded by said transmitter.

21. The receiver of claim 20 wherein said memory is organized as a circular buffer of N elements, said controller maintains a pointer marking the beginning of an out-of-order window holding said received, non-sequential data frames, and wherein the value of said pointer is updated by said message from said transmitter.

22. A wireless communication system, comprising:
a receiver receiving sequential data frames and requesting retransmission of said data frames not received in sequential order;
a transmitter sequentially transmitting said data frames to said receiver and having memory storing copies of transmitted data frames not acknowledged as received by said receiver, said transmitter discarding one or more said copies of transmitted data frames when said copies approach an available capacity of said memory and transmitting to said receiver an indication of which said copies were discarded.

23. The system of claim 22 wherein said transmitter and receiver operate according to a negative acknowledgement window protocol.

24. The system of claim 23 wherein said transmitter and receiver are Radio Link Protocol (RLP) peers.
